(19) United States
(12) Patent Application Publication
(10) Pub. No.: US 2008/0195411 A1
(43) Pub. Date: Aug. 14, 2008

(54) Sealed-Bid Auction Comprising Staged Bid Publication

(75) Inventors: Steven Phillip Gologorsky, Montville, NJ (US); Brian David Parlato, Hillsborough, NJ (US)

Correspondence Address: DEMONT & BREYER, LLC, 100 COMMONS WAY, Ste. 250, HOLMDEL, NJ, 07733, US

(73) Assignee: DEMONT & BREYER, LLC, Holmdel, NJ (US)

(21) Appl. No.: 12/105,843

(22) Filed: Apr. 18, 2008

Related U.S. Application Data
(63) Continuation of application No. 10/392,691, filed on Mar. 20, 2003.
Application No. 10/392,691 is a continuation-in-part of application No. 09/896,618, filed on Jun. 30, 2001.
(60) Provisional application No. 60/215,859, filed on Jul. 1, 2000.

(51) Int. Cl. G06Q 30/00

(52) U.S. Cl. 705/1

(57) ABSTRACT

A method of conducting a sealed-bid auction is disclosed that herds the bids into a smaller range than might otherwise occur. In accordance with the illustrative embodiment, each bid is classified into exactly one of a plurality of buckets. Each bucket, and the bids in the bucket, if there are any, are published at different times in accordance with a bid publishing schedule. The bids in each bucket are published simultaneously, and the bid publishing schedule dictates that buckets comprising bids that are more advantageous to the auction solicitor are published before buckets comprising bids that are less advantageous to the auction solicitor.

### REFERENCE TO RELATED APPLICATIONS

This application is a continuation of U.S. patent application Ser. No. 10/392,691, filed Mar. 20, 2003 (Attorney Docket: 620-023us), now pending, which itself is a continuation-in-part of:

U.S. patent application Ser. No. 09/896,618, filed 30 Jun. 2001, entitled “Bid Value-Based Public Opening Time Bid,” (Attorney Docket: 620-013us), now pending, which itself claims the benefit of:

U.S. provisional application Ser. No. 60/215,859, filed Jul. 1, 2000, entitled “Bid Value-Based Public Opening Time Bid,” (Attorney Docket: 620-003us”), expired, all three applications of which are incorporated by reference.

The following patent applications are incorporated by reference:

U.S. patent application Ser. No. 09/896,715, filed 30 Jun. 2001, entitled “Formula-Based Computerized Auctions” (Attorney Docket: 620-011us);

U.S. patent application Ser. No. 09/895,483, filed 30 Jun. 2001, entitled “Multi-Variable Computer-Based Auction” (Attorney Docket: 620-012us);

U.S. patent application Ser. No. 09/896,619, filed 30 Jun. 2001, entitled “System and Method for Computerized Auctions Having One or More Rounds of Bidding” (Attorney Docket: 620-014us);

U.S. patent application Ser. No. 09/895,482, filed 30 Jun. 2001, entitled “System and Method for Providing Interactive Auction Services” (Attorney Docket: 620-015us);

U.S. patent application Ser. No. 09/935,812, filed 23 Aug. 2001, entitled “Construction Quote System” (Attorney Docket: 620-018us);

U.S. patent application Ser. No. 09/938,141, filed 23 Aug. 2001, entitled “Intelligent Bids” (Attorney Docket: 620-020us); and

U.S. patent application Ser. No. 09/895,482, filed 26 Jan. 2002, entitled “Quote System” (Attorney Docket: 620-027us).

### FIELD OF THE INVENTION

The present invention relates to auctions in general, and, more particularly, to sealed-bid auctions.

### BACKGROUND OF THE INVENTION

In a traditional sealed-bid auction, an auctioneer indicates: (1) the scope of the auction, (2) when, where, and how sealed (i.e., secret) bids are to be submitted, and (3) when, where, and how the bids are to be published (i.e., “opened”). Although the sealed-bid auction format has been used for a long time and is the workhorse of governmental auctions, there are disadvantages with it.

First, because all of the bids in a sealed-bid auction are formulated independently and without knowledge of competing bids, there is no pressure on a bidder to improve its bid once it believes it has made a sufficiently competitive bid.

Second, because all of the bids in a sealed bid-auction are formulated independently and without knowledge of the competing bids, each bidder often formulates its bid without an objective indication of the range of reasonable bids, which information is sometimes only available after the auction is over.

Third, the most advantageous bids to the auction solicitor are often distributed over a wide range. This is troublesome for an auction solicitor who wishes, for whatever reason, to reject the best bid and instead to accept the second-best bid when there is a great difference in price between the best bid and the second-best bid.

Fourth, when the most advantageous bids to the auction solicitor are distributed over a wide range, the winning bidder is often confronted with the uncomfortable feeling—and sometimes politically-difficult position—that it unnecessarily and significantly outbid the second-best bid. This might leave the winning bidder angry and reluctant to perform its duties in good faith.

These problems confirm the need for an improved sealed-bid auction format.

### SUMMARY OF THE INVENTION

The present invention is an enhanced method of conducting a sealed-bid auction. The present invention is advantageous over prior art sealed-bid auctions because it tends to herd the bids into a smaller range than might otherwise occur. This is advantageous for two reasons.

First, in the event that the auction must be awarded to the bidder with the second or third best bid, there is likely to be only a small incremental difference in price between the second and third-best bids and the winning bid. This is advantageous to the auction solicitor who might have difficulty awarding the scope to a bidder with a bid that is substantially less-favorable than the “best” bid. Second, the herding of bids into a smaller range ameliorates the possibility that best bidders' might feel that it unnecessarily and significantly outbid the second-best bid.

Embodiments of the present invention are equally effective in both forward and reverse auctions, and in both single and multi-variable auctions. And furthermore, some embodiments of the present invention can meet current sealed-bidding laws.

In accordance with the illustrative embodiment, each bid is classified into exactly one of a plurality of buckets based on a bid classification plan. The bid classification plan can comprise either narrow buckets, wide buckets, or both. For the purposes of this specification, a “narrow” bucket is defined as a bucket that contains all of the bids, if there are any, at one permissible bid amount. In contrast, a “wide” bucket is defined as a bucket that contains all of the bids, if there are any, in a range of permissible bid amounts.

The illustrative embodiment operates in accordance with the following rules:
1. The contents (i.e., the bids) of each bucket, if there are any, are published at a time in accordance with a bid publishing schedule.
2. The bids in each bucket are published simultaneously or at substantially the same time.
3. The bid publishing schedule dictates that buckets comprising bids that are more advantageous to the auction solicitor are published before buckets comprising bids that are less advantageous to the auction solicitor.
4. The timing of the bidding phase and the resolution phase for each bucket is different than every other bucket.
5. The resolution phase of a more advantageous bucket ends before the bidding phase of a less-advantageous bucket ends.
6. A bid can be entered into the auction until the bucket for the bid is published.
7. A bid can be withdrawn from the auction until the bucket for the bid is been published.
8. A bid in the auction can be amended until either (i) the bucket for the pre-amended bid is published, or (ii) the bucket for the post-amended bucket is published.

The illustrative embodiment comprises: a method of conducting an auction in behalf of an auction solicitor, wherein the method comprises: receiving at a data processing system a plurality of bids in the auction; classifying each of the bids into one of a plurality of buckets based on the amount of the bid; and publishing the contents of each bucket at a different time.

### BRIEF DESCRIPTION OF THE DRAWINGS

FIG. 1 depicts a schematic diagram of the illustrative embodiment of the present invention in which data processing system 101 conducts an auction (i.e., is the auctioneer of an auction) in behalf of auction solicitor 102 and between bidders 103-1 through 103-n, wherein n is a positive integer greater than zero.

FIG. 2 depicts a block diagram of the salient components of data processing system 101.

FIG. 3 depicts a flowchart of the operation of the illustrative embodiment.

FIG. 4 depicts a flowchart of the subtasks that compose task 301.

FIG. 5 depicts a flowchart of the subtasks that compose task 302.

FIG. 6 illustrates the temporal relationship of the bidding phase and resolution phase in accordance with the illustrative embodiment.

FIG. 7 depicts a flowchart of the salient subtasks that compose task 503, the bidding and resolution phases of the auction.

FIG. 8 depicts a flowchart of the salient subtasks comprising subtask 704 in accordance with the illustrative embodiment.

### DETAILED DESCRIPTION

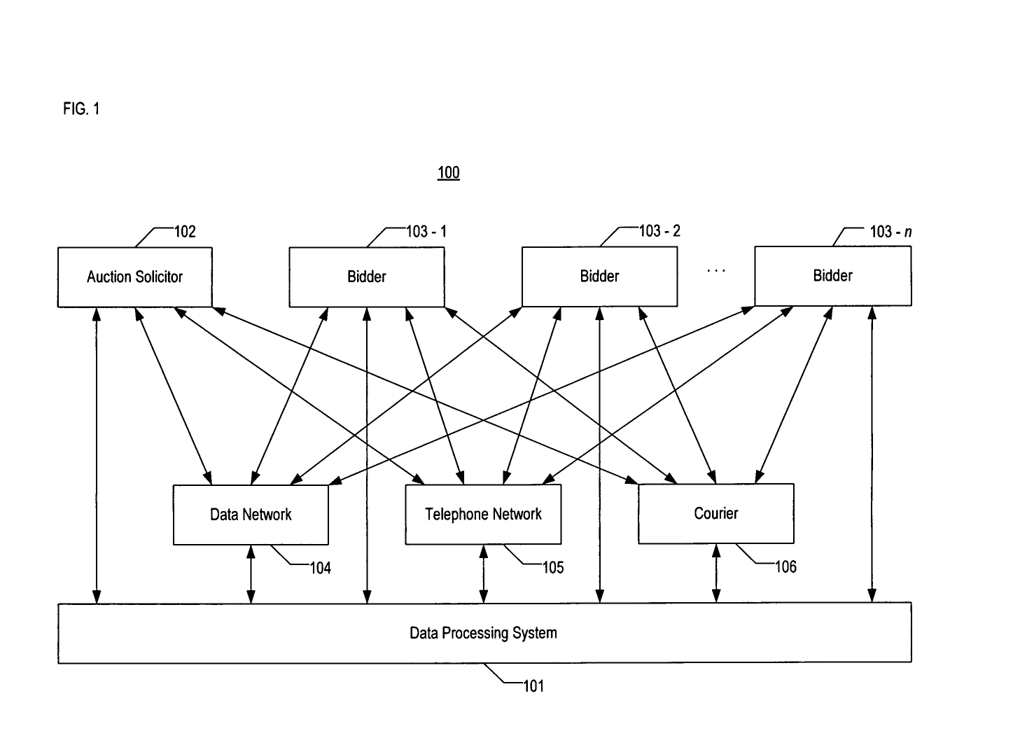

FIG. 1 depicts a schematic diagram of the illustrative embodiment of the present invention in which data processing system 101 conducts an auction (i.e., is the auctioneer of an auction) in behalf of auction solicitor 102 and between bidders 103-1 through 103-n, wherein n is a positive integer greater than zero. Data processing system 101 conducts the auction “in behalf” of the auction solicitor 102, rather than “on behalf” of the auction solicitor 102, because data processing system 101 and auction solicitor 102 can have, but do not necessarily have, an agent-principal relationship.

In accordance with the illustrative embodiment, data processing system 101 is owned and operated by one or more entities that are independent of auction solicitor 102 and bidders 103-1 through 103-n. In some alternative embodiments of the present invention, however, data processing system 101 is:
i. owned, or
ii. operated, or
iii. owned and operated,
   by
i. auction solicitor 102, or
ii. one or more of bidders 103-1 through 103-n, or
iii. both auction solicitor 102 and one or more of bidders 103-1 through 103-n.

In accordance with the illustrative embodiment, the owner or the operator or the owner and the operator of data processing system 101 receives a fee in consideration for conducting an auction in behalf of auction solicitor 102. In some embodiments of the present invention, the fee is paid by auction solicitor 102. In some alternative embodiments of the present invention, the fee is paid by one or more of bidders 103-1 through 103-n.

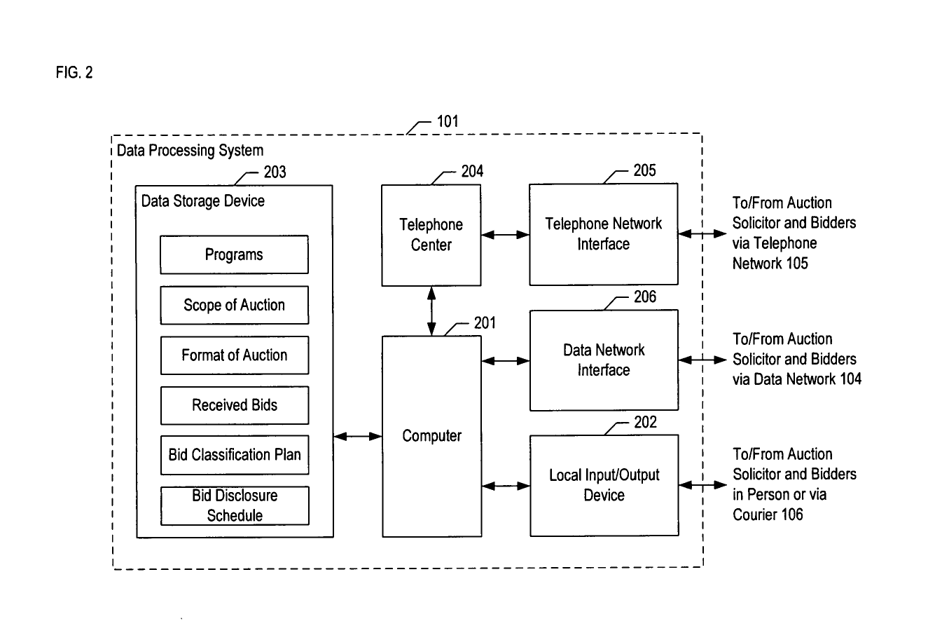

In accordance with the illustrative embodiment, auction solicitor 102 and bidders 103-1 through 103-n are capable of providing data to and receiving data from data processing system 101 via:
1. data network 104 (e.g., the Internet, a private data network, a local area network, a wireless data network, etc.), or
2. telephone network 105 (e.g., the Public Switched Telephone Network, a wireless telephony network, etc.), or
3. courier 106 (e.g., Federal Express, the U.S. Mail, publication in a newspaper, publication in a periodical, etc.), or
4. in person by being co-located with local input/output device 202 (shown in FIG. 2) of data processing system 101, or
5. any combination of i, ii, iii, and iv.
   It will be clear to those skilled in the art how to make and use embodiments of the present invention in which auction solicitor 102 and bidders 103-1 through 103-n communicate with data processing system 101 in person, through data network 104, telephone network 105, and/or courier 106.

FIG. 2 depicts a block diagram of the salient components of data processing system 101, which comprises computer 201, local input/output device 202, data storage device 203, telephone center 204, telephone network interface 205, and data network interface 206.

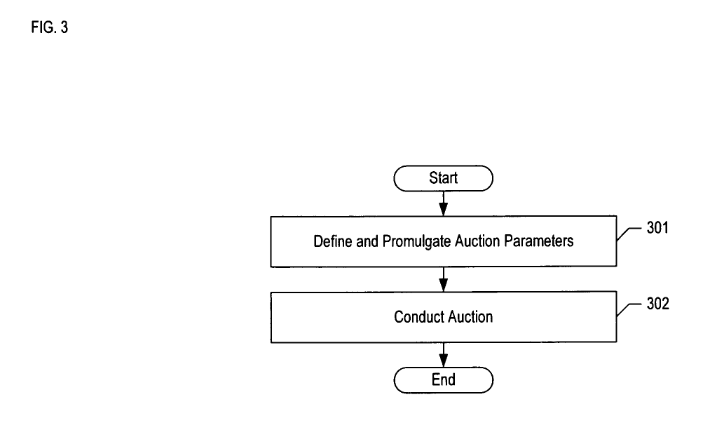

Computer 201 is a general-purpose processor that is capable of performing the functionality described below and with respect to FIGS. 3 through 5. For example, computer 201 is capable of:
executing one or more programs that are stored in data storage device 203;
storing data in and retrieving data from data storage device 203;
receiving data from and outputting data to local input/output device 202;
receiving data from and outputting data to telephone center 204; and receiving data from and outputting data to data network interface 206.

Local input/output device 202 comprises one or more machines (e.g., terminals, scanners, printers, disk drives, displays, etc.) into which data from auction solicitor 102 and bidders 103-1 through 103-n can be received and from which data from data processing system 101 can be output to auction solicitor 102 and bidders 103-1 through 103-n.

Data storage device 203 is a non-volatile memory (e.g., a hard disk, flash memory, a tape drive, an optical device, etc.) for storing the programs executed by computer 201 and the data input into computer 201 and generated by computer 201.

Data network interface 206 enables auction solicitor 102 and bidders 103-1 through 103-n to communicate with data processing system 101 via a data network, such as the Internet. For example, data processing system 101 can receive data and can output data via Web pages.

Auction solicitor 102 and bidders 103-1 through 103-n can communicate with data processing system 101 via telephone, such as through a toll-free “800” number. To this end, telephone network interface 205 comprises one or more telephones that are capable of receiving calls from and placing calls to auction solicitor 102 and bidders 103-1 through 103-n. Telephone network interface 205 can further comprise an automatic call distribution system, in well-known fashion, for routing incoming calls to the various telephones. Furthermore, telephone network interface 205 is capable of receiving information from auction solicitor 102 and bidders 103-1 through 103-n via a touch-tone interface wherein the parties input information to the system by pushing the buttons on their telephones in response to questions from an automated operator.

Telephone center 204 comprises one or more computer terminals that are operated by the personnel associated with telephone network interface 205 such that an operator (either human or automated) can shuttle data between computer 201 and a bidder and auction solicitor 102, who is in contact with data processing system 101 via telephone network interface 205.

It will be clear to those skilled in the art how to make and use computer 201, local input/output device 202, data storage device 203, telephone center 204, telephone network interface 205, and data network interface 206.

Although data processing system 101 in FIG. 2 is shown as depicting only one computer, one local input/output device, one data storage device, one telephone center, one telephone network interface, and one data network interface, it will be clear to those skilled in the art that a data processing system in accordance with the present invention can comprise:
i. one or more computers, or
ii. one or more local input/output devices, or
iii. one or more data storage devices, or
iv. one or more telephone centers, or
v. one or more telephone network interface, or
vi. one or more data network interfaces, or
vii. any combination of i, ii, iii, iv, v, vi, and vii.
   whether any combination of computers, local input/output devices, data storage devices, telephone centers, telephone network interfaces, and data network interfaces are networked (e.g., a wide area network, a local area network, etc.) or not networked (e.g., a sneakernet, etc.), that cooperate to perform the functionality described below and with respect to FIGS. 3 through 5. Furthermore, it will be clear to those skilled in the art that the various components of data processing system 101 need not be co-located, but can separated by hundreds or thousands of miles and networked (e.g., a wide area network, etc.) or not networked (e.g., a sneakernet, etc.).

FIG. 3 depicts a flowchart of the operation of the illustrative embodiment. For pedagogical purposes, the illustrative embodiment will be described in general and then it will be described in conjunction with an illustrative example. In accordance with this specification, the operation of the illustrative embodiment is described in terms of tasks and subtasks rather than steps because, as will be clear to those skilled in the art, some of the described tasks and subtasks can be performed in a single step. Furthermore, the illustrative embodiment is more easily understood when it is described in terms of its constituent tasks and subtasks that if it were described rigidly in terms of steps.

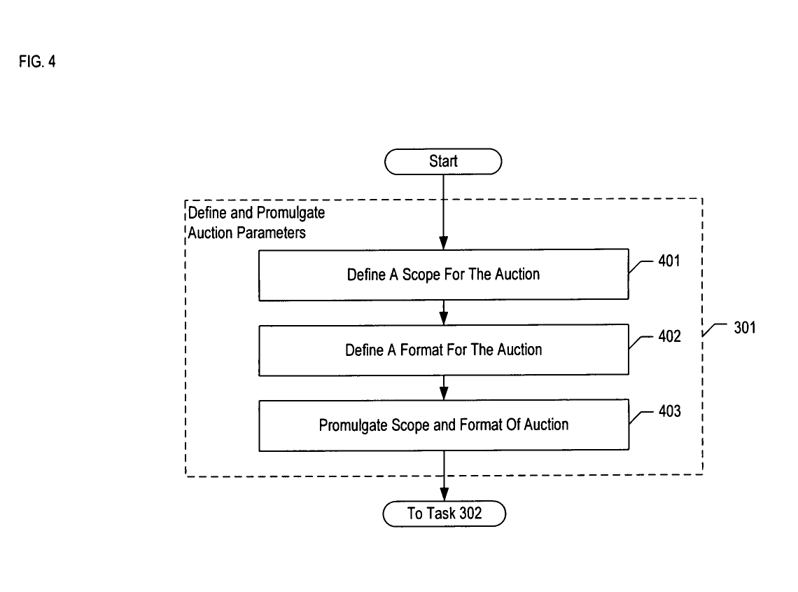

At task 301, the parameters of an auction are defined and promulgated. Although the auction solicitor typically initiates the need for the auction, and, therefore, the definition of the auction parameters, the auction solicitor might be assisted by consultants in the task of defining the auction parameters. In some alternative embodiments of the present invention, the operator of data processing system 101 can define some or all of the auction parameters. The details of task 301 are described below and with respect to FIG. 4 and its progeny.

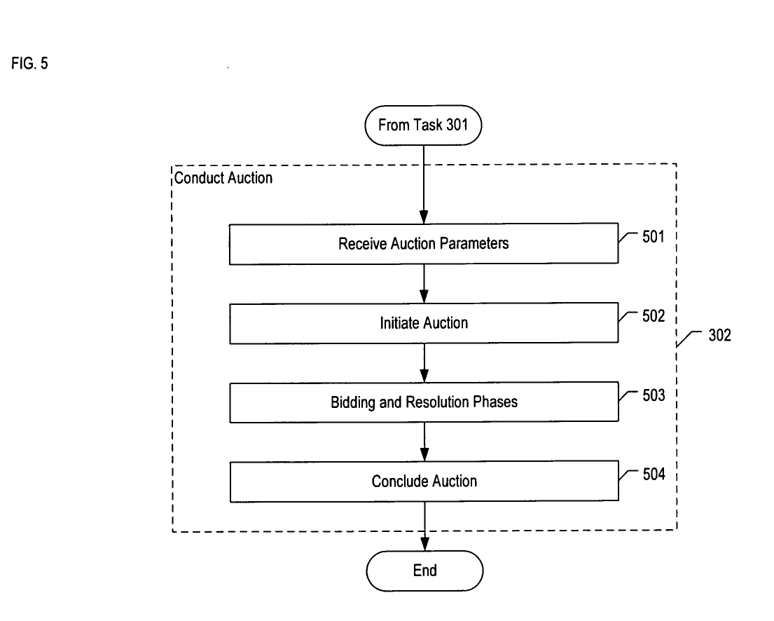

At task 302, the auction is conducted in accordance with the auction parameters that were defined and promulgated in task 301. The details of task 302 are described below and with respect to FIG. 5.

FIG. 4 depicts a flowchart of the subtasks that compose task 301.

At subtask 401, a scope for an auction is defined. For the purposes of this specification, the “scope” of an auction is defined as what the auction solicitor seeks to provide (e.g., information, money, services, goods, reality, intangible property, intellectual property, etc.) in consideration for what the auction solicitor seeks to acquire (e.g., information, money, services, goods, reality, intangible property, intellectual property, etc.) as a result of the auction.

For example, when an auction solicitor is a cinder block manufacturer who seeks to sell one lot of 5,000 cinder blocks to one of several masons, the scope of the auction might be to provide 5,000 cinder blocks in consideration for an amount of money to be determined as part of the auction. As another example, when the auction solicitor is a taxi and limousine company that seeks a 1-year service contract for its fleet, the scope of the auction might reasonably be to acquire 48 oil changes for the vehicles in its fleet in a 12-month interval in consideration for a number of taxi rides to be determined as part of the auction and an amount of money to be determined as part of the auction.

The scope of the auction can, but does not necessarily, define the mandatory and non-discretionary aspects of a qualified bid, when any have been indicated by auction solicitor 102 or data processing system 101. In other words, a bid that does not satisfy all of the mandatory and non-discretionary requirements that are indicated is void or voidable at the auction solicitor's election. For example, for the taxi and limousine company that seeks the oil changes for its fleet, the mandatory and non-discretionary aspects of the scope of the auction might be that the winning bidder must supply at least five quarts of 10W-40 Mobil® One® oil and one Framm® oil filter in each of the 48 specified oil changes.

The scope of the auction can, but does not necessarily, define the optional or discretionary aspects of a qualified bid. The optional or discretionary aspects of a qualified bid are not essential elements that a bid must possess in order to be a qualified bid, but are variable factors that affect how the various bids are ranked and the winning bid(s) determined. For example, for the taxi and limousine company that seeks the oil changes for its fleet, there are two discretionary aspects of a qualified bid: (1) the number of taxi rides to be provided by the taxi and limousine company to the winning bidder, and (2) the amount of money to be provided by the taxi and limousine company to the winning bidder. In other words, because the taxi and limousine company seeks to pay for the oil changes with a combination of money and services, each bid will comprise:

1. an indicium of the number of taxi rides, and

2. an indicium of the amount of money

that in combination the bidder is willing to accept in consideration for the oil changes. For example, this enables a first bidder to indicate that it is willing to accept 100 taxi rides and no money in exchange for the oil changes, a second bidder to indicate that it is willing to accept 25 taxi rides and $400 in exchange for the oil changes, and a third bidder to indicate that it is willing to accept no taxi rides and $825 in exchange for the oil changes.

The mandatory and non-discretionary aspects of a bid and the optional or discretionary aspects of a bid can involve the same aspect. For example, when an auction solicitor desires to buy a truck, the scope of an auction might specify that a mandatory and non-discretionary aspect of the bid is a two-year warranty and an optional or discretionary aspect of the bid is a warranty for more than two years. In other words, the length of a warranty can be both a mandatory and non-discretionary aspect of the bid and an optional or discretionary aspect of the bid so long as there is some demarcation of the line between the mandatory and non-discretionary aspect and the optional or discretionary aspect.

The scope of the auction can, but does not necessarily, define the mandatory and non-discretionary requirements of a qualified bidder, when any have been indicated by auction solicitor 102 or data processing system 101. In other words, a bid from a bidder who does not satisfy all of the mandatory and non-discretionary requirements that are indicated is void or voidable at the auction solicitor's election. For example, when an auction solicitor is a corporation that seeks to provide dental care for its employees, the mandatory and non-discretionary aspects of the scope of the auction might reasonably be that the bidder, to be a qualified bidder, must hold a current and valid license to practice dentistry.

The scope of the auction can, but does not necessarily, define the optional or discretionary aspects of a qualified bidder. The optional or discretionary aspects of a qualified bid are not essential elements that a bidder must possess in order to be a qualified bidder, but are factors that affect how the bid from the bidder is compared to other bids and how the winning bid(s) determined. Typically, the optional or discretionary aspects of a qualified bidder are framed in terms of a property of the bidder (e.g., how long the bidder has been in business, whether the bidder and the auction solicitor have ever done business before, the bidder's liquidity, etc.). For example, because the taxi and limousine company seeks to enter into a long-term contract, the company might reasonably place a premium in contracting with a bidder who is financially stable and who has been in business for a while. In this case, the scope of the auction might reasonably include as optional or discretionary aspects of the bid: (1) an indicium of the financial stability of the bidder, and (2) an indicium of the length of time that the bidder has been in business.

The mandatory and non-discretionary aspects of a bidder and the optional or discretionary aspects of a bidder can involve the same aspect. For example, when an auction solicitor desires to buy a truck, the scope of an auction might specify that a mandatory and non-discretionary aspect of the bidder is that the bidder has been in business for at least two years and an optional or discretionary aspect of the bidder is how long it has been in business for more than two years. In other words, the length of time that the bidder has been in business can be both a mandatory and non-discretionary aspect of the bidder and an optional or discretionary aspect of the bidder so long as there is some demarcation of the line between the mandatory and non-discretionary aspect and the optional or discretionary aspect.

In summary, the scope of the auction informs a candidate bidder with a complete and precise definition of:
i. what the auction solicitor seeks to acquire as a result of the auction,
ii. what the auction solicitor seeks to provide as a result of the auction,
iii. the mandatory and non-discretionary requirements of a qualified bid,
iv. the optional or discretionary aspects of a qualified bid,
v. the mandatory and non-discretionary requirements of a qualified bidder, and
vi. the optional or discretionary aspects of a qualified bidder.
   In accordance with the illustrative embodiment, each bid comprises two or more optional or discretionary aspects that in combination determine the ordinal ranking of the bid with respect to the other bids. As described below, the illustrative embodiment comprises a mechanism for enabling the objective comparison and ordinal ranking of bids that comprise two or more optional or discretionary aspects of the bid or bidder or bid and bidder.

At subtask 402, the format of the auction is established. For example, the format of an auction specifies, but is not limited to:
i. when or under what circumstances the auction begins and ends,
ii. whether the bids are sealed or not,
iii. how many units or lots of the scope will be competed for,
iv. whether the auction occurs in one or more rounds,
v. how bids are made,
vi. how bids are evaluated and compared,
vii. the range of permissible bid amounts,
viii. the bid classification plan,
ix. the bid publishing schedule, and
x. how the winning bid(s) is determined.
   For example, the illustrative embodiment can be used with, for example, one-sided auctions (e.g., the English auction format, the Dutch auction format, the Vickery auction format, the first-price, sealed-bid auction format, and their variants, etc.) and double-sided auctions (e.g., the continuous double auction format, the Double Dutch auction format, the Japanese auction format, and their variants, etc.).

In accordance with the illustrative embodiment, the bids are sealed. Furthermore, the bids are compared and ranked by plugging in the value of the optional or discretionary aspects associated with each bid into a formula to produce a resultant bid and then by ranking the resultant bids based on their relative magnitude.

In accordance with the illustrative embodiment, data processing system 101 receives T bids in an auction, wherein T is a positive integer greater than zero. In accordance with the illustrative embodiment, each bid, bₖ, wherein k=1 to T, comprises m bid variables, v_{1,k} through v_{m,k}. For the purposes of this specification, a “bid variable” is defined as discretionary or optional aspect of a bid. The integrity of the auction process is enhanced when the bid variables are defined in such a way that their values can be determined or verified objectively and not subjectively.

A bid variable can be, for example:
a binary bid variable (e.g., the inclusion or absence of a warranty in a bid, whether the bidder has or has not previously supplied similar scope to the auction solicitor in the past, whether the bidder has small disadvantaged business status, etc.); or
an integer bid variable (e.g., the number of workers to be assigned to a project, the number of computers to be tendered, etc.); or
a continuous bid variable (e.g., the fuel mileage of a dump truck, the length of time that a warranty will run, etc.).
   A binary bid variable has two possible values, TRUE or FALSE. An integer bid variable and a continuous bid variable can have no bounds (i.e., range from negative infinite to positive infinite), or can have a single bound (i.e., v₃>34), or can have two bounds (i.e., 34<v₃<57), or more than two bounds (i.e., 34<v₃<57 or v₃>135).

A bid variable can be a dimensioned or dimensionless quantity. Example dimensioned bid variables that relate to physical properties include, but are not limited to:
i. mass (e.g., the mass of a projectile, etc.);
ii. weight (i.e., force) (e.g., the weight of a portable computer, etc.);
iii. length (e.g., the length of an I-beam, the distance of the bidder's premises to the job site, the perimeter of a field, etc.);
iv. area (e.g., the area of a rug, etc.);
v. volume (e.g., the volume of a refrigerator, etc.);
vi. time (e.g., the length of time that a warranty will run, the number of years of experience that the bidder has in some field, when the bidder demands to be paid, etc.);
vii. electrical charge (e.g., the maximum number of coulombs held in a capacitor, etc.);
viii. energy (e.g., the storage capacity of a battery, etc.);
ix. power (e.g., the horsepower of an engine, etc.);
x. pressure (e.g., the average pressure created by a pump, etc.)
xi. velocity (e.g., the maximum speed of an aircraft, etc.);
xii. acceleration (e.g., the effectiveness of a parachute, etc.);
xiii. acidity (e.g., the pH of a dye, etc.);
xiv. a performance metric (e.g., the effectiveness of a drug in obtaining results, etc.); and
xv. any combination of i, ii, iii, iv, v, vi, vii, viii, ix, x, xi, xii, xiii, and xiv.
   Example dimensioned bid variables that relate to finance include, but are not limited to
i. money (e.g., the price for a hundred gallons of orange-juice, etc.);
ii. interest (e.g., the rate at which past due invoices will be charged interest, etc.);
iii. liquidity (e.g., the cash-to-asset ratio of the bidder, etc.); and
iv. financial stability (e.g., the credit rating of the bidder, etc.);
   Example dimensioned bid variables that relate to a property of the bidder itself include, but are not limited to:
i. a satisfaction metric (e.g., how pleased other parties have been with the past performance of the bidder as measured a survey, etc.);
ii. a performance metric (e.g., the effectiveness of a bidder in obtaining results, etc.);
iii. a financial stability metric (e.g., the credit rating of the bidder, etc.);
iv. a delivery history metric (e.g., the percentage of packages delivered by the bidder on time, etc.); and
v. a service metric (e.g., how often the bidder successfully completes repairs in only one service call, etc.).
   It will be clear to those skilled in the art how to define and utilize other bid variables in embodiments of the present invention. Furthermore, it will be clear to those skilled in the art that the degree of discretion that a bidder has to affect the value of a particular bid variable can range from no discretion to absolute discretion.

When data processing system 101 receives a bid, it produces a resultant bid, rₖ, for the bid, bₖ. In some alternative embodiments of the present invention, a bidder can submit the resultant bid, rₖ, with the m bid variables, v₁ through vₘ, as part of the bid. In these embodiments, data processing system 101 reproduces the resultant bid, rₖ, using its own parameters to verify the value of the resultant bid submitted.

In any case, the resultant bid, rₖ, is determined from the m bid variables, v_{1,k} through v_{m,k}, and c bid weights, w₁ through w_{c}. For the purposes of this specification, a “bid formula” is defined as the manner in which a plurality of bid variables are combined to produce a resultant bid. The general expression of the bid formula is depicted in Equation 1.

rₖ=f(v_{1,k},v_{2,k}, . . . , v_{m,k},w₁,w₂, . . . , w_{c}) (Eq. 1)

In accordance with the illustrative embodiment, the resultant bid, rₖ, is dimensioned in “equivalent dollars” for ease of description, which indicates that each of the c bid weights, w₁ through w_{c}, is dimensioned in units that when combined with the m bid variables, v_{1,k} through v_{m,k}, produce an output dimensioned in equivalent dollars. In some alternative embodiments of the present invention, the resultant bid, rₖ, is dimensioned in another dimension or is a dimensionless quantity.

In accordance with the illustrative embodiment, each of the c bid weights is a constant. In some alternative embodiments of the present invention, one or more of the c bid weights is a function of one or more of the bid variables (e.g., w₃=f(v₃), w₄=f(v₃, v₄), etc.). The function can be continuous (i.e., the derivative is defined over the range of interest) or discontinuous (i.e., the derivative is not defined everywhere within the range of interest).

Furthermore, in accordance with the illustrative embodiment, the signs of the c bid weights are chosen so that positive attributes of a bid (e.g., the fuel efficiency of an engine, etc.) have a different polarity than negative attributes of a bid (e.g., the amount of pollution created by an engine, etc.) to enable bid variables that indicate positive attributes of a bid to offset bid variables that indicate negative attributes of the bid. In any case it will be clear to those skilled in the art how to choose the respective values of the c bid weights, w₁ through w_{c}.

In accordance with the illustrative embodiment, the magnitude of the resultant bid, rₖ, is a linear function of the value of each of the m bid variables, v_{1,k} through v_{m,k}, as depicted in Equation 2.

$${r}_{k} = {\sum }_{j = 1}^{m} {w}_{j} {v}_{j , k} = {w}_{1} {v}_{1 , k} + {w}_{2} {v}_{2 , k} + … + {w}_{m} {v}_{m , k} \qquad ( Eq . 2 )$$

It will be clear to those skilled in the art how to make and use other bid formulas for use with other embodiments of the present invention. For example, it will be clear to those skilled in the art how to define a bid formula in which the magnitude of the resultant bid, rₖ, is a nonlinear function of the value of at least one of the m bid variables, v_{1,k} through v_{m,k}. For example, Equation 3 depicts an example of a bid formula in which the value of the resultant bid, rₖ, is a function of 2 bid variables, v_{1,k} and v_{2,k}, and 6 bid weights w₁ through w₆.

rₖ=w₁v_{1,k}³+w₂v_{1,k}²++w₃e^{v}^{_{1,k}}+w₄v_{1,k}v_{2,k}+w₅ sin(w₆v_{2,k}) (Eq. 3)

When the resultant bid, rₖ, for two or more bids are computed, the resultant bids are ranked based on their relative magnitude. When the auction has concluded, the bid associated with the resultant bid whose magnitude is most advantageous to the auction solicitor is declared the winning bid.

It should be understood that each bid comprises multiple bid variables not merely to break a tie between two bids that have the same value for one bid variable, but so that bids that have no ties in any one bid variables can be compared and ranked. That is not to say that two bids in accordance with the present invention cannot have the same value for a bid variable, but that the values of all of the bid variables affect the outcome of an auction. In some alternative embodiments of the present invention, however, no two bids have the same value for any one bid variable (i.e., v_{q,1} does not equal v_{q,2}, for q=1 to m) in one auction.

In accordance with the illustrative embodiment, a bid classification plan is defined, which classifies each bid into exactly one of a plurality of “buckets” based on the amount of the bid (in a single variable auction) or the resultant bid (in a multi-variable auction). Furthermore, the bid classification plan maps each permissible bid amount into exactly one bucket. The range of permissible bid amounts should large enough to encompass every conceivable realistic bid.

Each bucket can be either “narrow” or “wide.” For the purposes of this specification, a “narrow” bucket is defined as a bucket that contains all of the bids, if there are any, at one permissible bid amount. In contrast, a “wide” bucket is defined as a bucket that contains all of the bids, if there are any, in a range of permissible bid amounts.

A bid classification plan can comprise:
i. only narrow buckets, or
ii. only wide buckets, or
iii. a combination of one or more narrow buckets and one or more wide buckets.
   By definition, all narrow buckets have the same width (i.e., one permissible bid amount). In contrast, two wide buckets can have different widths (e.g., one has a width of ten permissible bid amounts and the second has a width of 15 permissible bid amounts, etc.). Furthermore, a wide bucket in a bid classification plan can have a different width than another wide bucket in the bid classification plan.

For example, the format of a reverse single-variable auction might specify the range of permissible bids as $1 to $100 in whole dollar increments (i.e., no bids with cents are permissible). In this auction, the bid classification plan might specify twelve (12) buckets as depicted in Table 1.

TABLE 1
Example Bid Classification Plan Comprising A Combination of 12
Wide and Narrow Buckets

| Bucket | Range | Width | Width |
|---|---|---|---|
| 1 | 1-19 | 19 | wide |
| 2 | 20-35 | 16 | wide |
| 3 | 36-45 | 10 | wide |
| 4 | 46-48 | 3 | wide |
| 5 | 49 | 1 | narrow |
| 6 | 50 | 1 | narrow |
| 7 | 51 | 1 | narrow |
| 8 | 52 | 1 | narrow |
| 9 | 53-55 | 3 | wide |
| 10 | 56-65 | 10 | wide |
| 11 | 66-81 | 16 | wide |
| 12 | 82-100 | 19 | wide |

In accordance with the illustrative embodiment, the bid classification plan has an “hourglass” shape, meaning that the buckets at the beginning and end of the bid classification plan are wider than the buckets in the middle of the bid classification plan. Furthermore, the “waist” of the bid classification plan has its waist centered at the most likely bid amounts.

In accordance with the illustrative embodiment, a bid publishing schedule is established, which dictates when each bucket is published by data processing system 101 to auction solicitor 102, bidders 103-1 through 103-n, and possibly the public at large. When the auction is a sealed-bid auction, the bid publishing schedule dictates when the bidders in the auction learn the details of the bids in the auction (i.e., when the bids are “opened” at least with respect to the other bidders in the auction).

In accordance with the illustrative embodiment, each bucket is published at a different time. When a bucket is published, all of the bids in the bucket, if there are any, are also published. The time interval between successive bucket publications can be uniform or non-uniform. In general, the time interval between successive bucket publications should be long enough so that a bidder who has observed the publication of a bucket has enough time to enter, withdraw, or amend a bid before the next bucket is published.

In accordance with the illustrative embodiment, all of the bids in a bucket are published simultaneously or at substantially the same time. It will be clear to those skilled in the art, after reading this specification, how to make and use embodiments of the present invention in which all of the bids in a bucket are published at different times.

In accordance with the illustrative embodiment, the bid publishing schedule dictates that the buckets for bids that are more advantageous to the auction solicitor are published before the buckets for bids that are less advantageous to the auction solicitor. Because the publication of a bucket implies the publication of the bids, if any, within the bucket, the bids that are more advantageous to the auction solicitor are published before the buckets for bids that are less advantageous to the auction solicitor are published.

For example, the bid publishing schedule might specify that the twelve (12) buckets in Table 1 are to be published at 5 minute intervals from 3:00 P.M. on a given day, as depicted in Table 2.

TABLE 2
Example Bid publishing plan

| | Time of |
|---|---|
| Bucket | Publication |
| 1 | 3:00 PM |
| 2 | 3:05 PM |
| 3 | 3:10 PM |
| 4 | 3:15 PM |
| 5 | 3:20 PM |
| 6 | 3:25 PM |
| 7 | 3:30 PM |
| 8 | 3:35 PM |
| 9 | 3:40 PM |
| 10 | 3:45 PM |
| 11 | 3:50 PM |
| 12 | 3:55 PM |

In some alternative embodiments of the present invention, the opening of some or all of the buckets is predicated on the occurrence or non-occurrence of some inevitable event.

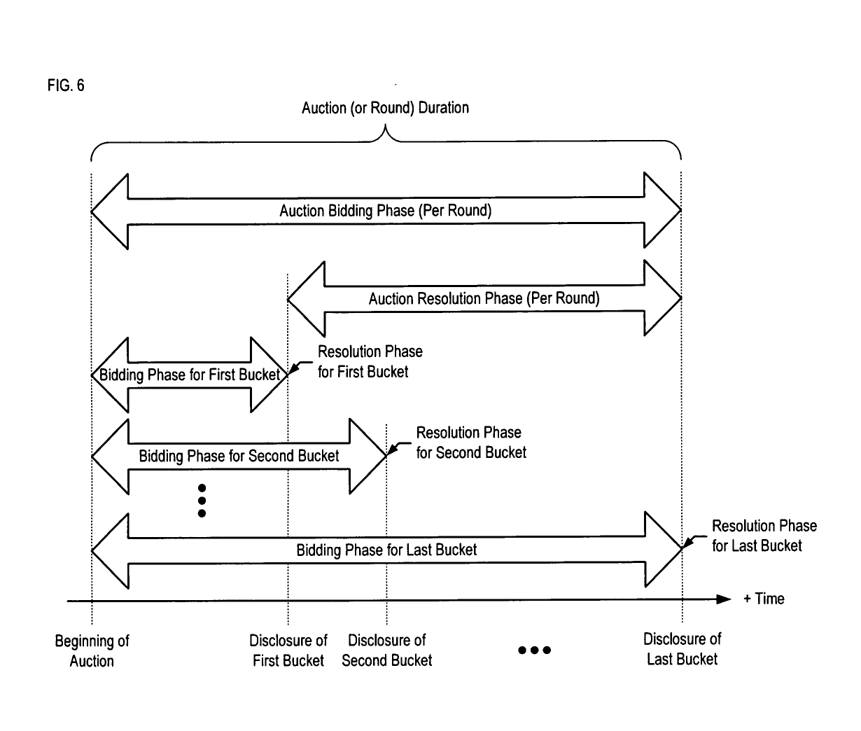

In accordance with the illustrative embodiment, the timing of the bidding phase and the resolution phase for each bucket is different than every other bucket, as shown in FIG. 6, and the resolution phase of a more advantageous bucket ends before the bidding phase of a less-advantageous bucket ends. In particular, a bid can be entered into the auction until the bucket for the bid has been published. Furthermore, a bid can be withdrawn from the auction until the bucket for the bid has been published. And still furthermore, an entered bid can be amended until either (i) the bucket for the pre-amended bid has been published, or (ii) the bucket for the post-amended bucket has been published.

With continuing reference to FIG. 4, it will be seen at subtask 403 that the scope of the auction and the format of the auction is promulgated to candidate bidders.

This can be achieved, illustratively, via:
1. data network 104 (e.g., the Internet, a private data network, a local area network, a wireless data network, etc.), or
2. telephone network 105 (e.g., the Public Switched Telephone Network, a wireless telephony network, etc.), or
3. courier 106 (e.g., Federal Express, the U.S. Mail, publication in a newspaper, publication in a periodical, etc.), or
4. in person by being co-located with local input/output device 202 (shown in FIG. 2) of data processing system 101, or
5. any combination of i, ii, iii, and iv.

FIG. 5 depicts a flowchart of the subtasks that compose task 302.

At subtask 501, the auction parameters (e.g., the scope of the auction, the format of the auction, the bid formula, etc.) are received by data processing system 101. This enables data processing system 101 to conduct the auction in accordance with the auction parameters.

At subtask 502, the auction is initiated. In accordance with the illustrative embodiment of the present invention, data processing system 101 signals the beginning of the auction. When the auction format includes multiple bidding rounds, data processing system 101 signals the beginning and ending of each round. In any case, it will be clear to those skilled in the art how to initiate the auction.

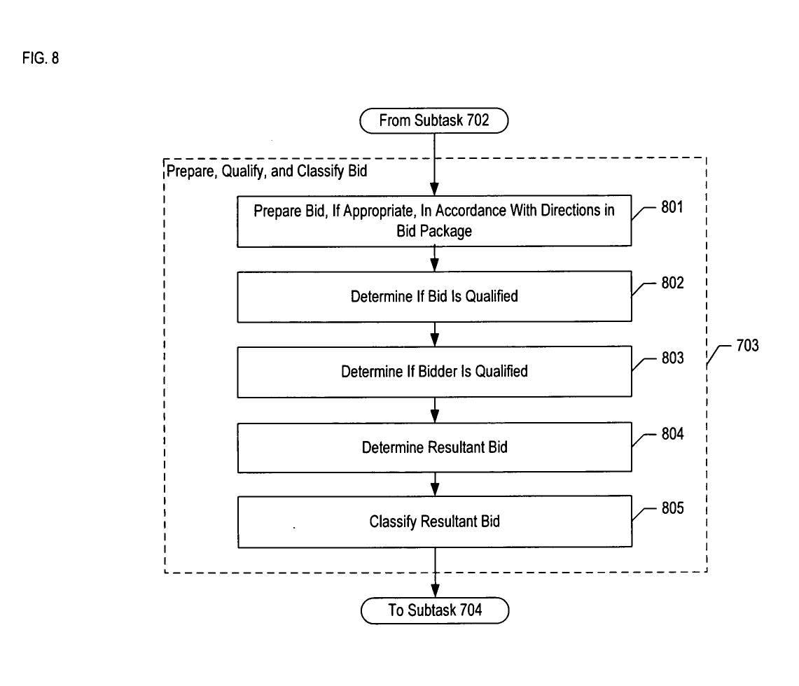

At subtask 503, the bidding and resolution phases of the auction are conducted. When the auction comprises multiple rounds, subtask 503 is performed once for each round. Subtask 503 is described in detail below and with respect to FIG. 8.

At subtask 504, the auction ends and data processing system 101 outputs an indicium of the winning bid (when the auction format specifies that there is one winning bid) or bids (when the auction format specifies that there is more than one winning bid) when the auction format indicates that the auction has ended. This information is distributed to auction solicitor 102 and bidders 103-1 through 103-n via:
i. data network 104 (e.g., the Internet, a private data network, a local area network, a wireless data network, etc.), or
ii. telephone network 105 (e.g., the Public Switched Telephone Network, a wireless telephony network, etc.), or
iii. courier 106 (e.g., Federal Express, the U.S. Mail, publication in a newspaper, publication in a periodical, etc.), or
iv. in person by being co-located with local input/output device 202 (shown in FIG. 2) of data processing system 101, or
v. any combination of i, ii, iii, and iv.

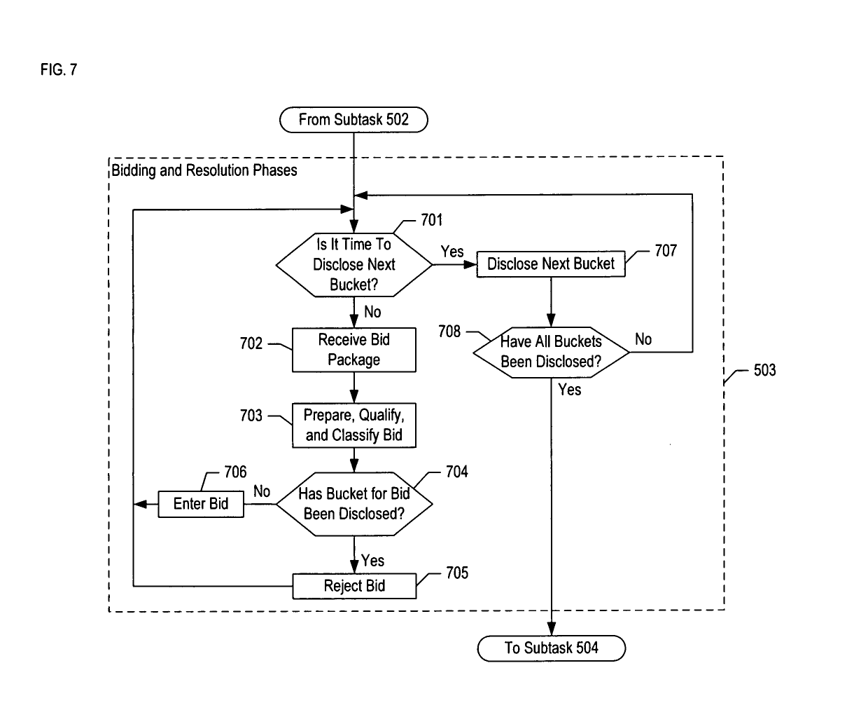

FIG. 7 depicts a flowchart of the salient subtasks that compose task 503, the bidding and resolution phases of the auction.

At subtask 701, the illustrative embodiment decides whether it is time to publish the next bucket, which is determined by comparing the real time to the bid publishing schedule. When the answer to this question is yes, control passes to subtask 707; otherwise control passes to subtask 702.

At subtask 702, the illustrative embodiment receives a bid package from a bidder. In the course of subtask 503, the illustrative embodiment receives T bid packages, bpₖ, wherein k=1 to T, wherein T is a positive integer greater than zero.

In accordance with the illustrative embodiment, the bid packages can be received by data processing system 101 concurrently or periodically or sporadically during the auction, as specified by the format of the auction.

In accordance with the illustrative embodiment, each bid package, bpₖ, is received by data processing system 101 via:
i. data network 104 (e.g., the Internet, a private data network, a local area network, a wireless data network, etc.), or
ii. telephone network 105 (e.g., the Public Switched Telephone Network, a wireless telephony network, etc.), or
iii. courier 106 (e.g., Federal Express, the U.S. Mail, publication in a newspaper, publication in a periodical, etc.), or
iv. in person by being co-located with local input/output device 202 (shown in FIG. 2) of data processing system 101, or
v. any combination of i, ii, iii, and iv.
   In accordance with the illustrative embodiment, each bid package, bpₖ, comprises at least:
1. a direction to enter a bid, bₖ, into the auction;
2. a value for each of the m bid variables, v_{1,k} through v_{m,k}, associated with the bid;
3. one or more indicium that the bid satisfies the mandatory and non-discretionary aspects of a qualified bid; and
4. one or more indicium that the bidder satisfies the mandatory and non-discretionary aspects of a qualified bidder.
   In accordance with the illustrative embodiment, the value of each of the m bid variables, v_{1,k} through v_{m,k}, is:
i. explicitly stated in the bid package; or
ii. implicitly stated in the bid package; or
iii. determined by data processing system 101 by reference to a default value; or
iv. determined by data processing system 101 by reference to public information; or
v. determined by data processing system 101 by reference to private information; or
vi. determined in accordance with any combination of i, ii, iii, iv, and v.
   For example, the first bid package from each bidder explicitly states a value for each of the m bid variables, v_{1,k} through v_{m,k}, that are not determined by default or incorporated by reference. Furthermore, subsequent bid packages only explicitly state a value for those bid variables whose value has changed from the last bid. In this case, the bid variables whose value has not changed from the previous bid can be reasonably deemed to be implicitly stated in the bid package.

The auction format might indicate a default value for one or more of the m bid variables, v_{1,k} through v_{m,k}, such that a bid package need not explicitly state a value for those bid variables unless the bidder desires to override the default value.

A bid package, bpₖ, might instruct data processing system 101 to determine the value of one or more of the m bid variables, v_{1,k} through v_{m,k}, by reference to public or private information. For example, data processing system 101 might be instructed to determine the value of a bid variable by reference to another bidder's bid (e.g., v_{k,1} equals v_{k-1,1} plus $50, etc.), other bid variables of bidder's bid, or the financial markets (e.g., v_{1,k} equals the S&P 500 index at 10:00 AM today minus 25.00, etc.).

From subtask 702, control passes to subtask 703.

At subtask 703, data processing system 101 prepares, qualifies, and classifies the bid spawned by the bid package in subtask 702. This is described in detail below and with respect to FIG. 8. From subtask 702, control passes to subtask 704.

At subtask 704, data processing system 101 decides whether the bucket for the bid classified in subtask 703 has been published. When the answer to this question is yes, control passes to subtask 705; otherwise control passes to subtask 706.

At subtask 705, the bid that was classified in subtask 703 is rejected, and the bidder and bid package (as the bidder's alter ego) is notified that the bid was rejected. From subtask 705, control passes to subtask 701.

At subtask 706, the bid that was classified in subtask 703 is entered into the auction into the appropriate bucket. From subtask 706, control passes to subtask 701.

At subtask 707, the bucket due to be published is published by data processing system 101. When data processing system 101 publishes a bucket, it necessarily also publishes each bid in the bucket, the value of the m bid variables associated with the resultant bid an indicium of whether the bid is qualified or not, and an indicium of whether the bidder who made the bid is qualified or not. In some alternative embodiments of the present invention, when a bid is published, the values of some of the m bid variables might not be disclosed.

For unqualified bids and bids from unqualified bidders, data processing system 101 publishes with each resultant bid an indicium that the resultant bid is unqualified or is a qualified bid from a unqualified bidder or both. This informs all of the bidders that that bid is void or voidable at the election of auction solicitor 102, and, therefore, need not necessarily be overcome to win the auction. In other words, a bidder might not feel the need to overcome a candidate winning (but unqualified) bid to win the auction when the bidder is confident that the auction solicitor will void the candidate winning (but unqualified) bid.

This information is published to auction solicitor 102 and bidders 103-1 through 103-n via:
i. data network 104 (e.g., the Internet, a private data network, a local area network, a wireless data network, etc.), or
ii. telephone network 105 (e.g., the Public Switched Telephone Network, a wireless telephony network, etc.), or
iii. courier 106 (e.g., Federal Express, the U.S. Mail, publication in a newspaper, publication in a periodical, etc.), or
iv. in person by being co-located with local input/output device 202 (shown in FIG. 2) of data processing system 101, or
v. any combination of i, ii, iii, and iv.

Data processing system 101 also at subtask notes which buckets have been published because this information is used by data processing system 101 in subtasks 704 and 708. From subtask 707, control passes to subtask 708.

At subtask 708, data processing system 101 decides if all of the buckets have been published, which means the bidding and resolution phases of the auction have ended. When the answer to this question is yes, control passes to subtask 504; otherwise control passes to subtask 701.

FIG. 8 depicts a flowchart of the salient subtasks comprising subtask 703 in accordance with the illustrative embodiment.

At subtask 801, data processing system 101 prepares a bid, bₖ, as indicated in bid package, bpₖ. Furthermore, in accordance with the illustrative embodiment, a bidder can program data processing system 101 to enter one or more bids by proxy (i.e., to automatically submit one or more bid under various specified circumstances and with bid variables that depend on various specified circumstances that are determinable by data processing system 101).

In accordance with the illustrative embodiment, each bid, bₖ, comprises at least:
i. an explicit value for each of the m bid variables, v_{1,k} through v_{m,k};
ii. one or more indicium that the bid satisfies the mandatory and non-discretionary aspects of a qualified bid; and
iii. one or more indicium that the bidder satisfies the mandatory and non-discretionary aspects of a qualified bidder.
   Regardless of whether each bid variable was explicitly stated in the bid package or implicitly stated in the bid package or determined by data processing system 101 by reference to a default value or determined by data processing system 101 by reference to public information or determined by data processing system 101 by reference to private information or determined in accordance with any combination of these, data processing system 101 determines the explicit value for each bid variable, when necessary, and includes it with the bid. In other words, even when bid package does not comprise an explicit value for a bid variable, the bid associated with the bid package does explicitly comprise an explicit value for the bid variable.

At subtask 802, data processing system 101 determines whether each bid received in subtask 504 is a qualified bid by, for example, comparing the one or more indicium that the bid satisfies the mandatory and non-discretionary aspects of a qualified bid. When the bid does not qualify, it is void or voidable at the election of auction solicitor 102. In accordance with the illustrative embodiment, data processing system 101 can, of its own initiative, retrieve public information or private information and can determine, in whole or in part, by reference to the retrieved information whether a bid prepared in subtask 801 is qualified.

At subtask 803, data processing system 101 determines whether each bidder who submitted a bid that was prepared in subtask 801 is a qualified bidder by, for example, checking the one or more indicium that the bid satisfies the mandatory and non-discretionary aspects of a qualified bid against the mandatory and non-discretionary aspects of the bidder as defined in the scope of the auction. When the bidder does not qualify, that bidder's bids are void or voidable at the discretion of auction solicitor 102. In accordance with the illustrative embodiment, data processing system 101 can, of its own initiative, retrieve public information or private information and can determine, in whole or in part, by reference to the retrieved information whether a bidder who submitted a bid that was prepared in subtask 801 is qualified.

At subtask 804, data processing system 101 determines a resultant bid, rₖ, for the bid, bₖ, based on the bid formula received in subtask 501 and on the m bid variables, v_{1,k} through v_{m,k}, stated in bid, bₖ.

At subtask 805, data processing system 101 classifies the bid, bₖ, in accordance with the bid classification plan and the amount of the bid. In multivariable auctions, the amount of the bid is the resultant bid, rₖ. This is done for both qualifying bids and unqualified bids and for bids from both qualifying bidders and unqualified bidders.

As indicated above, for pedagogical purposes the illustrative embodiment is now described in conjunction with an example auction. In accordance with the example, an auction solicitor desires to purchase a truck and defines the scope of the auction as follows:

The auction solicitor seeks to acquire a truck in consideration for cash.
The mandatory and non-discretionary requirements of a qualified bid are:
the truck must have a diesel engine,
the truck must have a minimum engine size of 400 horsepower,
the truck must have a minimum hauling capacity of 20 tons,
the truck must have a two-year warranty or longer,
the truck must have a maximum height of 13 feet, and
the purchase of the truck must be financed by the winning bidder.
   The optional or discretionary aspects of a qualified bid (i.e., some of the bid variables) are:
the engine size of the truck (in excess of 400 hp),
the hauling capacity of the truck (in excess of 20 tons),
the color of the truck,
the length of the warranty (in excess of 2 years),
the fuel efficiency of the truck,
the CO₂ emissions of the truck, and
the price of the truck.
   The mandatory and non-discretionary requirements of a qualified bidder are:
the bidder must have sold trucks for at least three years, and
the bidder must have a repair facility within 50 miles of the auction solicitor's location.
   The optional or discretionary aspects of a qualified bidder (i.e., more bid variables) are:
the distance of the bidder's repair facility from the auction solicitor's location, and
the interest rate that the bidder will charge the auction solicitor in financing the sale of the truck.

The auction solicitor has determined that unqualified bids are void, but bids from unqualified bidder are voidable by the auction solicitor after an investigation of the bidder's reputation.

The auction solicitor has defined the format of the auction as follows: The auction will begin on Jul. 1, 2005 at 12:00 Noon EST and will end on Jul. 1, 2005 at 12:50 P.M. EST. The bids can be submitted at any time during the auction. The bids are sealed. There is only one unit being sought, and, therefore, there will only be one winning bid. The auction comprises only one round. Bid packages are to be delivered to data processing system 101 at any time between 11:00 Noon and 12:50 P.M. The bid variables are:

TABLE 3
Bid Variables for the First Illustrative Auction

| Bid | |
|---|---|
| Variable | Description |
| v₁ | the engine size of the truck (in horsepower) |
| v₂ | the hauling capacity of the truck (in tons) |
| v₃ | the color of the truck (1 for a yellow truck; 0 for any other |
| | color truck) |
| v₄ | the length of the warranty (in years) |
| v₅ | the fuel efficiency of the truck (in miles per gallon) |
| v₆ | the CO₂ emissions of the truck (in pounds per gallon of fuel) |
| v₇ | the price of the truck (in dollars) |
| v₈ | the distance of the bidder's repair facility from the auction |
| | solicitor's location (in miles) |
| v₉ | the interest rate that the bidder will charge the auction solicitor |
| | in financing the sale of the truck (in annualized basis points) |

The auction solicitor has decided that the bid formula for bid, bₖ, is:

$${r}_{k} = {w}_{1} ( {v}_{1 , k} - 400 ) + {w}_{2} ( {v}_{2 , k} - 20 ) + {w}_{3} {v}_{3 , k} + {w}_{4} ( {v}_{4 , k} - 2 ) + {w}_{5} {v}_{5 , k} + {w}_{6} {v}_{6 , k} + {w}_{7} {v}_{7 , k} + {w}_{8} {v}_{8 , k} + {w}_{9} {v}_{9 , k} \qquad ( Eq . 4 )$$

and that the winning bid will be the bid with the smallest resultant bid at the end of the auction.

The auction solicitor has decided that the nine bid variables have the relative value to the auction solicitor defined by the following bid weights:

TABLE 4
Bid weights for the First Illustrative Auction

| Bid Weight | Comment |
|---|---|
| w₁ = −$30 per horsepower (in excess of 400 hp) | note that v₁ ≧ 400 to |
| | be a qualified bid |
| w₂ = −$150 per ton (in excess of 20 tons) | note that v₂ ≧ 20 to be |
| | a qualified bid |
| w₃ = −$500 | |
| w₄ = −$1000 per year of warranty (in excess | note that v₄ ≧ 2 to be |
| of 2 years) | a qualified bid |
| w₅ = −$50 per mpg | |
| w₆ = +$10 per pound of CO₂ per gallon of fuel | |
| w₇ = +1 | |
| w₈ = +$20 per mile | note that v₈ < 50 to be |
| | a qualified bid |
| w₉ = +$5 per annualized basis point | |

Note that w₁, w₂, w₃, w₄, and w₅ are negative because higher values of bid variables v₁, v₂, v₃, v₄, and v₅ are more advantageous to the auction solicitor than lower values, and w₆, w₇, w₈, and w₉ are positive because lower values of bid variables v₆, v₇, v₈, and v₉ are more advantageous to the auction solicitor than higher values.

The auction solicitor has decided that the bids will be published in stages in accordance with a bid classification plan and a bid publishing schedule. The bid classification plan will comprise five (5) wide buckets, as depicted in Table 5, each of which will be published at a time shown in Table 6.

TABLE 5
Bid Classification Plan

| | Bucket Range (Resultant |
|---|---|
| Bucket | Bid) |
| #1 | $240,000-$253,999 |
| #2 | $254,000-$255,999 |
| #3 | $256,000-$256,999 |
| #4 | $257,000-$257,999 |
| #5 | $258,000-$299,999 |

TABLE 6
Bid Publishing Schedule

| Bucket | Time Published |
|---|---|
| #1 | Jul. 1, 2005 - 12:10 PM |
| | EST |
| #2 | Jul. 1, 2005 - 12:20 PM |
| | EST |
| #3 | Jul. 1, 2005 - 12:30 PM |
| | EST |
| #4 | Jul. 1, 2005 - 12:40 PM |
| | EST |
| #5 | Jul. 1, 2005 - 12:50 PM |
| | EST |

On Jul. 1, 2005 at 12:00 Noon EST, the auction commences.

The first event in the auction occurs at 12:02 EST, when a first bid, b₁, is submitted by a first bidder to data processing system 101 with the following bid variables:

TABLE 7
Bid Variables for Bid 1

| Bid | |
|---|---|
| Variable | Value |
| v_{1,1} | 405 horsepower |
| v_{2,1} | 25 tons |
| v_{3,1} | Blue = 0 |
| v_{4,1} | 2 Years |
| v_{5,1} | 16 mpg |
| v_{6,1} | 2 pounds of CO₂ per gallon of |
| | fuel |
| v_{7,1} | $258,000 |
| v_{8,1} | 28 miles |
| v_{9,1} | 550 basis points |

After the first bid has been received, T=1. After the first bid and first bidder are determined to be qualified, data processing system 101 uses the bid formula (Equation 4) and the bid weights as defined in Table 4, to generate the resultant bid, r₁, which equals: $259,630. The first bid is then classified in accordance with the bid classification plan, which places it in bucket #5.

The second event in the auction occurs at 12:07 EST, when a second bid, b₂, is submitted by a second bidder to data processing system 101 with the following bid variables:

TABLE 8
Bid Variables for Bid 2

| Bid | |
|---|---|
| Variable | Value |
| v_{1,2} | 475 horsepower |
| v_{2,2} | 28 tons |
| v_{3,2} | Red = 0 |
| v_{4,2} | 3 Years |
| v_{5,2} | 14 mpg |
| v_{6,2} | 2.5 pounds of CO₂ per gallon of |
| | fuel |
| v_{7,2} | $259,000 |
| v_{8,2} | 16 miles |
| v_{9,2} | 560 basis points |

After the second bid has been received, T=2. Data processing system 101 uses the bid formula (Equation 4) and the bid weights as defined in Table 4, to generate the resultant bid, r₂, which equals: $256,995.

In this case, the second bid is determined to be qualified, but the second bidder is determined to be unqualified. In accordance with the auction format, the auction solicitor can at its discretion void the bid from bidder #2.

The second bid is classified in accordance with Table 4, which places it in bucket #3.

The third event in the auction occurs at 12:10 EST, when the first bucket is published in accordance with the bid publishing schedule. When the first bucket is published, data processing system 101 publishes to the auction solicitor, bidders and other interested parties the fact that it contains no bids.

The fourth event in the auction occurs at 12:20 EST, when the second bucket is published in accordance with the bid publishing schedule. When the second bucket is published, data processing system 101 publishes to the auction solicitor, bidders and other interested parties the fact that it too contains no bids.

The fifth event in the auction occurs at 12:16 EST, when a third bid, b₃, is submitted by a third bidder to data processing system 101 with the following bid variables:

TABLE 9
Bid Variables for Bid 3

| Bid | |
|---|---|
| Variable | Value |
| v_{1,1} | 450 horsepower |
| v_{2,1} | 26 tons |
| v_{3,1} | Yellow = 1 |
| v_{4,1} | 2.5 Years |
| v_{5,1} | 14 mpg |
| v_{6,1} | 2 pounds of CO₂ per gallon of |
| | fuel |
| v_{7,1} | $258,000 |
| v_{8,1} | 24 miles |
| v_{9,1} | 550 basis points |

After the third bid has been received, T=3. After the third bid and third bidder are determined to be qualified, data processing system 101 uses the bid formula (Equation 4) and the bid weights as defined in Table 4, to generate the resultant bid, r₃, which equals: $257,150. The third bid is then classified in accordance with the bid classification plan, which places it in bucket #4.

The sixth event in the auction occurs at 12:30 EST, when the third bucket is published in accordance with the bid publishing schedule. When the third bucket is published, data processing system 101 publishes to the auction solicitor, bidders and other interested parties the fact that it contains a bid, the values of the bid variables and the resultant bid associated, and the fact that Bidder #2 is unqualified.

At this point, Bidder #2 has won the auction but its bid might be voided by the auction solicitor. Therefore, the incentive still exists for other bidders to come in second because they might be awarded the contract if the bid from Bidder #2 is voided.

The seventh event in the auction occurs at 12:23 EST, when the first bidder decides to improve its bid in an attempt to have the second best bid. To this end, the first bidder withdraws bid b₁ and submits a new bid, b₄, to data processing system 101 with the following bid variables:

TABLE 10
Bid Variables for Bid 4

| Bid | |
|---|---|
| Variable | Value |
| v_{1,1} | 405 horsepower |
| v_{2,1} | 25 tons |
| v_{3,1} | Yellow = 1 |
| v_{4,1} | 2½ Years |
| v_{5,1} | 16 mpg |
| v_{6,1} | 2 pounds of CO₂ per gallon of |
| | fuel |
| v_{7,1} | $257,250 |
| v_{8,1} | 28 miles |
| v_{9,1} | 525 basis points |

After the fourth bid has been received, T=4. After the fourth bid and first bidder are determined to be qualified, data processing system 101 uses the bid formula (Equation 4) and the bid weights as defined in Table 4, to generate the resultant bid, r₄, which equals: $257,755. The fourth bid is then classified in accordance with the bid classification plan, which places it in bucket #4.

The eighth event in the auction occurs at 12:40 EST, when the fourth bucket is published in accordance with the bid publishing schedule. When the fourth bucket is published, data processing system 101 publishes to the auction solicitor, bidders and other interested parties the fact that it contains two bids—bid #3 and bid #4—and the values of the associated bid variables and the resultant bids.

The ninth and final event in the auction occurs at 12:50 EST, when the fifth bucket is published in accordance with the bid publishing schedule. When the second bucket is published, data processing system 101 publishes to the auction solicitor, bidders and other interested parties the fact that it contains no bids.

At this point, the auction ends with the following results:

TABLE 11
Auction Results.

| Standing | Bidder | Amount |
|---|---|---|
| 1^{st} | Bidder #2 | $256,995 |
| 2^{nd} | Bidder #3 | $257,150 |
| 3^{rd} | Bidder #1 | $257,755 |

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method of conducting a sealed-bid auction in behalf of an auction solicitor, the method comprising:
receiving, at a data processing system, a first sealed bid and a second sealed bid in the sealed-bid auction;
classifying, at the data processing system, the first sealed bid into a first bucket based on a bid classification plan;
classifying, at the data processing system, the second sealed bid into a second bucket based on the bid classification plan; and
publishing, at the data processing system, the first bucket before publishing the second bucket.

2. The method of claim 1 wherein the bid classification plan dictates that the first bucket is for all of the bids, if any, at a first permissible bid amount; and
wherein the bid classification plan dictates that the second bucket is for all of the bids, if any, at a second permissible bid amount.

3. The method of claim 1 wherein the bid classification plan dictates that the first bucket is for all of the bids, if any, at a first permissible bid amount; and
wherein the bid classification plan dictates that the second bucket is for all of the bids, if any, in a first range of permissible bid amounts.

4. The method of claim 1 wherein the bid classification plan dictates that the first bucket is for all of the bids, if any, in a first range of permissible bid amounts; and
wherein the bid classification plan dictates that the second bucket is for all of the bids, if any, in a second range of permissible bid amounts.

5. The method of claim 4 wherein the first range of permissible bid amounts has the same width as the second range of permissible bid amounts.

6. The method of claim 4 wherein the first range of permissible bid amounts has a different width than the second range of permissible bid amounts.

7. The method of claim 1 wherein all of the bids in the first bucket are published simultaneously.

8. The method of claim 1 wherein all of the bids in the first bucket are published at different times.

9. The method of claim 1 wherein the sealed-bid auction is a single-round auction. for one lot.

10. The method of claim 1 wherein the sealed-bid auction is an auction for one lot.

11. A method of conducting a sealed-bid auction in behalf of an auction solicitor, the method comprising:
receiving, at a data processing system, a first sealed bid from a first bidder;
classifying, at the data processing system, the first sealed bid into a first bucket in accordance with a bid classification plan;
entering, at the data processing system, the first sealed bid into the auction;
receiving, at the data processing system, a second sealed bid from a second bidder;
classifying, at the data processing system, the second sealed bid into a second bucket in accordance with the bid classification plan;
entering, at the data processing system, the second sealed bid into the auction except when the second bucket has been published; and
publishing, at the data processing system, the first bucket at a different time than the second bucket.

12. The method of claim 11 wherein the sealed-bid auction is a single-round auction.

13. The method of claim 11 wherein the sealed-bid auction is an auction for one lot.

14. The method of claim 11 wherein the bid classification plan dictates that the first bucket is for all of the bids, if any, at a first permissible bid amount; and
wherein the bid classification plan dictates that the second bucket is for all of the bids, if any, at a second permissible bid amount.

15. The method of claim 11 wherein the bid classification plan dictates that the first bucket is for all of the bids, if any, at a first permissible bid amount; and
wherein the bid classification plan dictates that the second bucket is for all of the bids, if any, in a first range of permissible bid amounts.

16. The method of claim 11 wherein the bid classification plan dictates that the first bucket is for all of the bids, if any, in a first range of permissible bid amounts; and
wherein the bid classification plan dictates that the second bucket is for all of the bids, if any, in a second range of permissible bid amounts.

17. The method of claim 16 wherein the first range of permissible bid amounts has the same width as the second range of permissible bid amounts.

18. The method of claim 16 wherein the first range of permissible bid amounts has a different width than the second range of permissible bid amounts.

19. A method of conducting a sealed-bid auction in behalf of an auction solicitor, the method comprising:
receiving, at a data processing system, a plurality of sealed bids for the sealed-bid auction;
classifying, at the data processing system, each of the sealed bids into exactly one of a plurality of buckets based on a bid classification plan; and
publishing, at the data processing system, each bucket at a different time than every other bucket in accordance with a bid publication plan;
wherein the buckets at the beginning and end of the bid classification plan are wider than the buckets in the middle of the bid classification plan.

20. The method of claim 19 wherein the bid publication plan specifies uniform intervals between successive bucket publications.

21. The method of claim 19 wherein the bid publication plan specifies non-uniform intervals between successive bucket publications.

22. The method of claim 19 wherein the bid publication plan specifies that all of the bids in each bucket are published at substantially the same time.

23. The method of claim 19 wherein the bid publication plan specifies that all of the bids in each bucket are published at substantially the same time.
